(19) United States
(12) Patent Application Publication
(10) Pub. No.: US 2013/0147270 A1
(43) Pub. Date: Jun. 13, 2013

(54) POWER SUPPLY DEVICE FOR COMPUTING DEVICES

(71) Applicants: KUEI-CHIH HOU, Tu-Cheng (TW); YU-CHI TSAI, Tu-Cheng (TW)

(72) Inventors: KUEI-CHIH HOU, Tu-Cheng (TW); YU-CHI TSAI, Tu-Cheng (TW)

(21) Appl. No.: 13/653,436

(22) Filed: Oct. 17, 2012

(30) Foreign Application Priority Data
Dec. 9, 2011 (TW) 100223310

(51) Int. Cl. H02J 9/00

(52) U.S. Cl. 307/23

(57) ABSTRACT

A power supply device for a computing device includes a voltage converter unit and an energy storage unit. The voltage converter unit converts an alternating current (AC) voltage of an external AC power supply to a direct current (DC) voltage and outputs the DC voltage to the computing device. The energy storage unit receives the DC voltage output by the voltage converter unit to charge a rechargeable battery of the energy storage unit as long as the AC voltage of the external AC power supply is higher than a predetermined threshold voltage, and outputs a DC voltage from the rechargeable battery to the computing device if the external AC power supply falls below the threshold voltage.

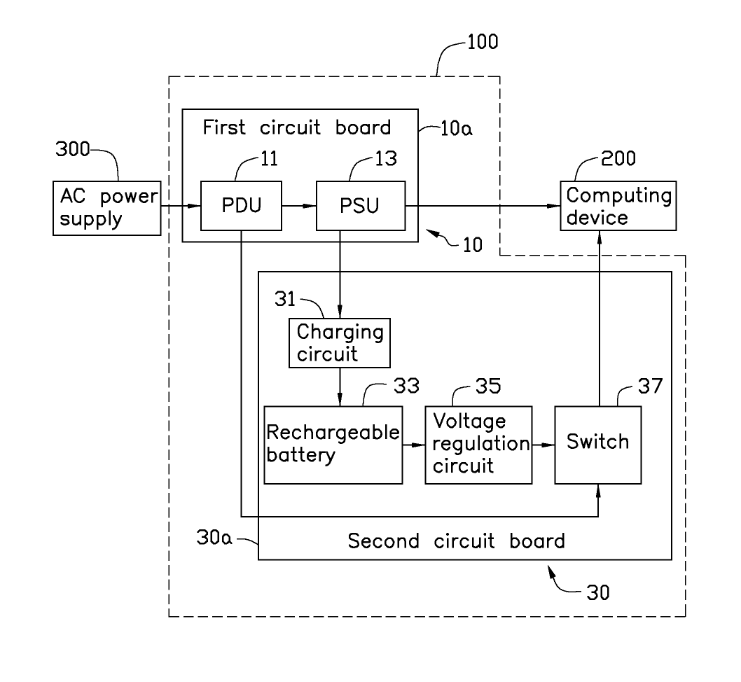

### BACKGROUND

1. Technical Field

The present disclosure relates to power supply devices, and particularly to a power supply device for computing devices.

2. Description of Related Art

Many computing devices obtain electrical power using power distribution units (PDUs). In use, a PDU of a computing device can receive an alternating current (AC) voltage from an external power supply (e.g., a wall socket), and convert the AC voltage into a direct current (DC) voltage for use by the computing device.

A computing device may further include an energy storage unit configured for maintaining the computing device to continue working when the external power supply malfunctions or is suddenly turned off. The energy storage unit generally includes an AC/DC converter, a rechargeable battery, and a DC/AC converter. The AC/DC converter is electrically connected between the external power supply and the battery, and the DC/AC converter is electrically connected between the battery and the PDU. When the external power supply provides the AC voltage to the computing device as normal, the AC/DC converter converts the AC voltage into a DC voltage to charge the battery. If the external power supply malfunctions or is suddenly turned off, the DC/AC converter converts a DC voltage of the battery into an AC voltage, and transmits the AC voltage to the PDU. The PDU converts the AC voltage provided by the energy storage unit into a DC voltage used by the computing device.

In the above-described method for using the energy storage unit, both the AC/DC converting process and the DC/AC converting process may cause loss of electrical power. Therefore, when the energy storage unit supplies electrical power to the computing device, the utilization efficiency of the electrical power received from the external power supply may be low.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

The FIGURE is a block diagram of a power supply device, according to an exemplary embodiment.

### DETAILED DESCRIPTION

The FIGURE is a block diagram of a power supply device 100, according to an exemplary embodiment. The power supply device 100 supplies electrical power to a computing device 200. The power supply device 100 includes a voltage converter unit 10 and an energy storage unit 30 electrically connected to each other. The voltage converter unit 10 is electrically connected to an external alternating current (AC) power supply 300, such as a wall socket, and converts an AC voltage of the AC power supply 300 to a direct current (DC) voltage used by the computing device 200. The energy storage unit 30 stores electrical power in the form of the DC voltage generated by the voltage converter unit 10, and supplies the stored electrical power to the computing device 200 when the AC power supply 300 malfunctions or is suddenly turned off.

The voltage converter unit 10 includes a first circuit board 10a, a power distribution unit (PDU) 11, and a power supply unit (PSU) 13. The PDU 11 and the PSU 13 are mounted on the first circuit board 10a and electrically connected to each other. The PDU 11 is electrically connected to the AC power supply 300, and receives and transmits the AC voltage of the AC power supply 300 to the PSU 13. If the AC voltage of the AC power supply 300 is a single-phase AC voltage, the PDU 11 directly transmits the single-phase AC voltage to the PSU 13. If the AC voltage of the AC power supply 300 is a multiphase (e.g., three-phase) AC voltage, the PDU 11 transforms the multiphase AC voltage into single-phase AC voltages and transmits the single-phase AC voltages to the PSU 13. Further, the PDU 11 controls the energy storage unit 30 to supply electrical power to the computing device 200. The PSU 13 can be an AC/DC converter or an adapter electrically connected between the PDU 11 and the computing device 200. The PSU 13 converts the single AC voltage transmitted from the PDU 11 into a DC voltage. The DC voltage is used by the computing device 200, and also charges the energy storage unit 30.

The energy storage unit 30 includes a second circuit board 30a, a charging circuit 31, a rechargeable battery 33, a voltage regulation circuit 35, and a switch 37. The second circuit board 30a is structurally independent from the first circuit board 10a. The charging circuit 31, the rechargeable battery 33, the voltage regulation circuit 35, and the switch 37 are all mounted on the second circuit board 30a, and are electrically connected in series between the PSU 13 and the computing device 200. Both the charging circuit 31 and the voltage regulation circuit 35 are DC/DC converters. Further, the PDU 11 is electrically connected to the switch 37 and controls the operation of the switch 37.

In use, the PDU 11 receives the AC voltage of the AC power supply 300, and transmits the AC voltage to the PSU 13. According to the above-described method, the PSU 13 always receives a single-phase AC voltage whether the AC voltage received by the PDU 11 is a single-phase AC voltage or otherwise. The PSU 13 converts the single AC voltage to a DC voltage that is adapted for the computer 200, and outputs the DC voltage to the computing device 200 to supply working electrical power.

At the same time, the DC voltage is input to the charging circuit 31. The charging circuit 31 regulates the DC voltage to a predetermined charging voltage for the rechargeable battery 33, and charges the rechargeable battery 33 using the charging voltage. If the AC power supply 300 is working normally, the PDU 11 detects that the AC voltage of the AC power supply 300 is higher than a predetermined threshold voltage. Thus, the PDU 11 maintains the switch 37 in an off state, and the rechargeable battery 33 is prevented from discharging.

If the AC power supply 300 malfunctions or is suddenly turned off, the PDU 11 detects that the AC voltage of the AC power supply 300 is reduced. If the AC voltage of the AC power supply 300 falls below the threshold voltage, the PDU 11 turns on the switch 37. Thus, the rechargeable battery 33 is electrically connected to the computing device 200. The voltage regulation circuit 35 regulates a DC voltage output by the rechargeable battery 33 and outputs a new DC voltage that is adapted to the use of the computing device 200 (e.g., similar to the DC voltage output by the PSU 13), and outputs the DC voltage to the computing device 200 to maintain normal working. In this way, the computing device 200 is protected from sudden loss of electrical power, and has time to store current working processes and data.

In the power supply device 100, the use of the energy storage unit 30 only requires regulating values of DC voltages, and the need for AC/DC and DC/AC converting processes is avoided. Therefore, the utilization efficiency of the electrical power of the AC power supply 300 is improved. Furthermore, because the first circuit board 10a and the second circuit 30a are structurally independent from each other, if either the voltage converter unit 10 or the energy storage unit 30 malfunctions, detachment for repair or replacement is easy.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device, comprising:
a voltage converter unit configured to convert an alternating current (AC) voltage of an external AC power supply into a direct current (DC) voltage and output the DC voltage to a computing device; and
an energy storage unit electrically connected to the voltage converter unit and the computing device, the energy storage unit including a rechargeable battery;
wherein the energy storage unit receives the DC voltage output by the voltage converter unit to charge the rechargeable battery when the AC voltage of the external AC power supply is higher than a predetermined threshold voltage, and outputs a DC voltage of the rechargeable battery to the computing device when the AC voltage of the external AC power supply falls below the threshold voltage.

2. The power supply device of claim 1, wherein the voltage converter unit includes a power distribution unit (PDU) and a power supply unit (PSU), and the PDU and the PSU are electrically connected in series between the external AC power supply and the computing device; the PDU receives the AC voltage of the external AC power supply and transmits the AC voltage of the external AC power supply to the PSU, and the PSU converts the AC voltage of the external AC power supply into the DC voltage output by the voltage converter unit.

3. The power supply device of claim 2, wherein when the AC voltage of the AC power supply is a single-phase AC voltage, the PDU directly transmits the single-phase AC voltage to the PSU; and when the AC voltage of the AC power supply is a multiphase AC voltage, the PDU transforms the multiphase AC voltage into a single-phase AC voltage and transmits the single-phase AC voltage to the PSU.

4. The power supply device of claim 3, wherein the energy storage unit further includes a charging circuit, a voltage regulation circuit, and a switch, and the charging unit, the rechargeable battery, the voltage regulation circuit, and the switch are electrically connected in series between the PSU and the computing device.

5. The power supply device of claim 4, wherein the PDU is electrically connected to the switch and detects the AC voltage of the external AC power supply, and the PDU controls the switch to be turned off when the AC voltage of the external AC power supply is higher than the threshold voltage, and controls the switch to be turned on when the AC voltage of the external AC power supply falls below the threshold voltage.

6. The power supply device of claim 5, wherein when the switch is turned off, the charging circuit regulates the DC voltage output by the voltage converter unit to a predetermined charging voltage, and charges the rechargeable battery using the charging voltage.

7. The power supply device of claim 5, wherein when the switch is turned on, the voltage regulation circuit regulates the DC voltage of the rechargeable battery to a new DC voltage according to use of the computing device, and outputs the new DC voltage to the computing device.

8. The power supply device as claimed of claim 4, wherein the voltage converter unit further includes a first circuit board, the energy storage unit further includes a second circuit board, and the first and second circuit boards are structurally independent from each other.

9. The power supply device of claim 8, wherein both the PDU and the PSU are mounted on the first circuit board, and the charging circuit, the rechargeable battery, the voltage regulation circuit, and the switch are all mounted on the second circuit board.
